(19) United States
(12) Patent Application Publication
(10) Pub. No.: US 2005/0172035 A1
(43) Pub. Date: Aug. 4, 2005

(54) Presenting an information item on a media system

(76) Inventor: Steven Morris, TAIPEI (TW)

Correspondence Address: PHILIPS INTELLECTUAL PROPERTY & STANDARDS, P.O. BOX 3001, BRIARCLIFF MANOR, NY, 10510, US

(21) Appl. No.: 10/507,679

(22) PCT Filed: Feb. 18, 2003
(86) PCT No.: PCT/IB03/00692

(51) Int. Cl. G06F 3/00

(52) U.S. Cl. 710/1; 345/204

(57) ABSTRACT

A method and a media system of/for presenting an information item from a first set of information items. The media system can be a Web-TV, a browser or a Web device. In the method and the media system each information item of the first set of information items is accessible by a reference (link, an URL Web or Wap address), where each reference for a given information item comprises a second set of preferences, and where each preference of the second set is having a predetermined value. The preferences can be set to present the media content item with no content at all, with sound, with images, with no text, with audio, with a generated speech, with links, an alert to an incoming call or a SMS received. The method includes the step of presenting (100) a given information item from the first set of information items where the presentation format is dependent of the values of the second set of preferences belonging to the given information item and where the values of the second sets of preferences is further dependent of a mode representing a context of a specific user. The context can be a situation where a media system is used. The situation can be a meeting, a drive, in an office conference. The method further includes the steps of selecting (200) a mode, modifying (300) the values of the preferences belonging to the selected mode, adding (400) and removing (401) a mode, and retrieving (500) the information item in the presentation format of the selected mode from a server to the media system.

This invention relates to a method of presenting an information item from a first set of information items on a media system, wherein each information item of the first set of information items is accessible by a reference, and wherein each reference for a given information item comprises a second set of preferences, each preference of the second set having a predetermined value.

Said information item of the first set of information items may be accessible by a reference, which may be a link, e.g. an URL as a Web or a Wap address known from the world of the Internet from a list of bookmarks, where the list of bookmarks may be a list of preferred links, URLs, etc. previously provided to the media system. The second set of preferences may subsequently be used to present each information item in a particular dedicated presentation format on the media system.

The present invention further relates to a computer system for performing the method.

The present invention further relates to a computer program product for performing the method.

The present invention further relates to media system for performing the method.

At present, web browsers typically only display HTML pages in one representation, i.e. the display or the presentation of the pages. On a desktop or on a laptop PC, this is acceptable because the available screen or display has a relatively big area with the possibility to show colours and or moving graphics, which makes formatting issues with respect to how to present a Web page less important. Typically, the only option available for controlling the presentation of a web page is to enable or disable the display of images, and this is an option within the web browser that will apply to all presented content of web pages.

With the advent of web access from various devices, i.e. mobile web access and WAP access from mobile phones and Personal Digital Assistants, however, many different representations of a web page are becoming necessary, and these may be generated either automatically by a so called trans-coding software on the originating server or by the web device selectively presenting information. The trans-coding software is used to—on the fly—to tailor a presentation of the web page to a specific device. In the latter case, the user may be able to choose between several different representations of the content on his device.

However, the representation that is suitable for one type of content of a particular web page may not be suitable for another web page. Many web browsers on handheld devices have limited presentation capabilities, both due to display resolution and or due to the physical size and due to the processing power required to render the content of a received web page or the like. For this reason, web page content that was originally not developed for display on a mobile device requires a different presentation on a mobile device to achieve easy navigation in the content or to be displayed in a readable manner.

Browsers of the prior art currently support a bookmark list, i.e. they provide links to interesting or useful web pages that the user chooses to store for later viewing. Typically the bookmark contains a list of frequently visited web pages, and is even more useful on a handheld or non-PC device, where entering a URL string may be a difficult and inconvenient operation. Typically, bookmarks are given names relating to the subject of the web pages stored under the given bookmark name.

The conference paper “FlexXML: Engineering a More Flexible and Adaptable Web” by Alan Kaplan and Jack Lunn, Department of Computer Science Clemson University, Proceedings International Conference on Information Technology: Coding and Computing, pp. 405-410, Published: Los Alamitos, Calif., USA 2001, xiv+698 pp discloses how Web sites are tailored to a specific Web device. Based upon the Web user's preferences and the Web browser environment, the FlexXML framework of the said conference paper includes the steps of automatically selecting an XSL style sheet, creating a document and delivering an appropriate content for presentation on the Web device.

The problem of the presentation techniques of browsers known from the Internet is that a selected preference for displaying and/or presentation generally applies to all web pages and all web content to be presented; the problem is also that that the presentation preference applies to all situations or contexts of the user. The user may be in a situation where, for a certain Web page, he wants all possible information shown to him, whereas he may be another situation where, for the same Web page, he merely desires to have a quick text overview, i.e. he now desires to have only the characters of the page presented to him. The presentation techniques of these browsers may not be suitable in the case where the user may have different goals during the use of the Web browser and/or they may not be suitable in the case where the user switches to the use of a presentation of a web page on a browser on another physical device. The object of the invention is therefore to provide different presentation and display capabilities of a browser to achieve that the web pages of various bookmarks can easily be presented and displayed with settings belonging to a given bookmark and/or to a given selected context of the user.

The above problem is solved by a method of the type mentioned, when the method comprises the step of:
presenting a given information item from the first set of information items where the presentation format is dependent of the values of the second set of preferences belonging to the given information item.

Hereby, the presentation of the information item, i.e. the content linked from an URL, Web or Wap address, may be presented dependent of the values of the second set of preferences belonging to said information item.

Hereby, the object of providing different presentation and display capabilities of a browser is achieved since the web pages can be presented and displayed with settings, i.e. the second set of preferences, belonging to each page.

When the values of the second sets of preferences further depend on a mode selectable from a third set of modes—each mode of the third set representing a context of a specific user—then the object of providing different presentation and display capabilities dependent of a given selected context of the user are further achieved.

The context—represented by said mode—may be a situation wherein a particular media system with a certain display and/or playback capability is used. The situation may be participation in a meeting, during the driving, in an office conference, etc.

In a preferred embodiment of the method, the method further comprises the step of:
selecting a mode, wherein the mode selected is selected from the third set of modes.

Hereby, the user of the media device may select another mode in order to have another presentation format on his media system.

In another preferred embodiment of the method, the method further comprises the step of:
modifying the values of the second sets of preferences belonging to the selected mode.

Hereby, the user of the media device may modify the values of the preferences of the already selected mode, also in order to have another presentation format on his media system.

In a preferred embodiment of the method, said step of selecting a mode comprises the sub-steps of:
presenting the values of the preferences for at least one mode, if any, from the third set of modes; or
presenting a representation of at least one mode belonging to the third set of modes; and
selecting a second mode on the basis of a user input, wherein the second mode is selected from the third set of modes.

Hereby, the user of the media system may, in the first step, watch the values of the preferences for one or more modes, or, secondly he may see a symbolised presentation of one or more modes, and, finally, he may select a new mode among the available modes.

In a preferred embodiment of the method, said step of modifying the values of the second sets of preferences belonging to the selected mode comprises the sub-steps of:
presenting the values of the second sets of preferences;
modifying, on the basis of a user input, at least one value of the second set of preferences; and
storing the modified value to the second set of preferences.

Hereby, the user of the media system may, in the first step, watch the values of the preferences for the selected mode, secondly he may modify one or more values of the preferences, and, finally, he may store the value to the selected mode.

In another preferred embodiment of the method, the method further comprises the step of:
adding a third mode, on the basis of a user, to the third set of modes; or
removing a fourth mode, on the basis of a user input, from the third set of modes.

In these two steps, a user may add or remove a mode to/from the number of modes.

In a preferred embodiment of the method, the method further comprises the step of:
retrieving the information item in the presentation format of the selected mode from a server to the media system.

Hereby, the content of the information item—when needed—may be retrieved from the server to the media system.

In a preferred embodiment of the method, the media system may be a Web-TV, a browser or a Web device.

The problem is also solved by a media system for presenting an information item from a first set of information items, wherein each information item of the first set of information items is accessible by a reference, and wherein each reference for a given information item comprises a second set of preferences, each preference of the second set having a predetermined value, said media system comprising:
means for presenting a given information item from the first set of information items where the presentation format is dependent of the values of the second set of preferences belonging to the given information item.

Embodiments of the media system are described in claims 12 to 18.

The media system gives the same advantages for the same reasons as described previously in relation to the method.

The invention will be explained more fully below in connection with preferred embodiments and with reference to the drawings, in which:

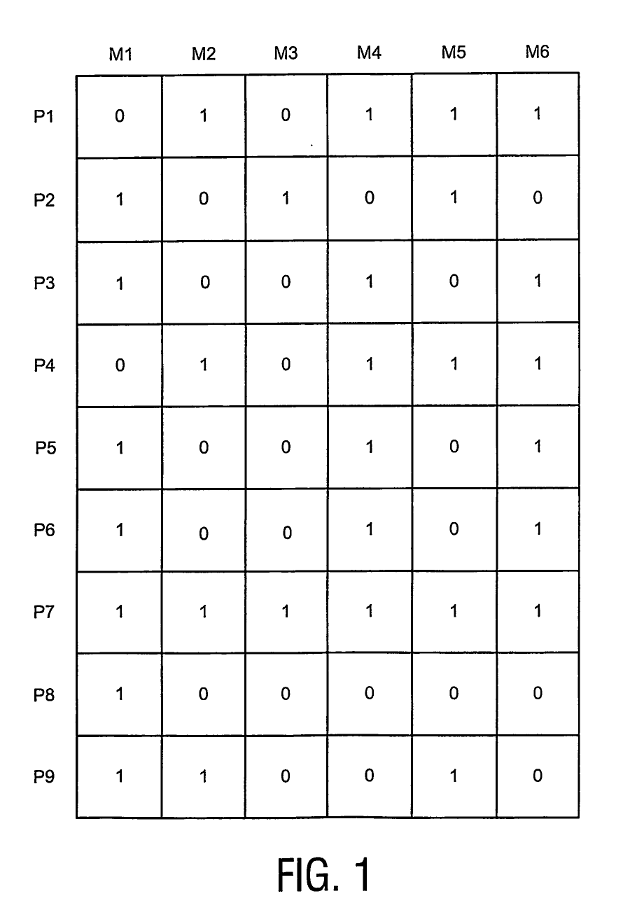

FIG. 1 shows a data-structure;

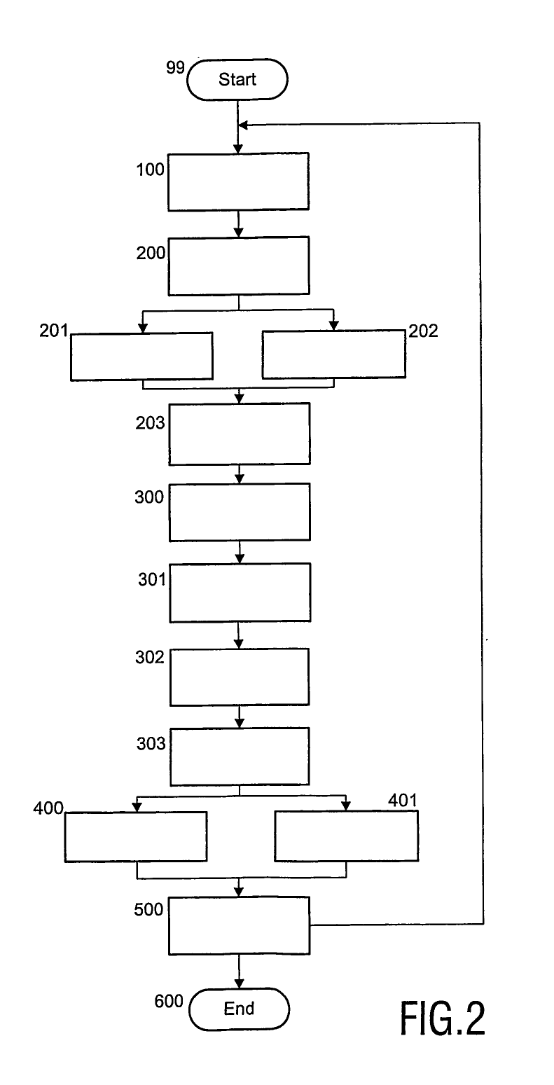

FIG. 2 shows method of presenting an information item; and

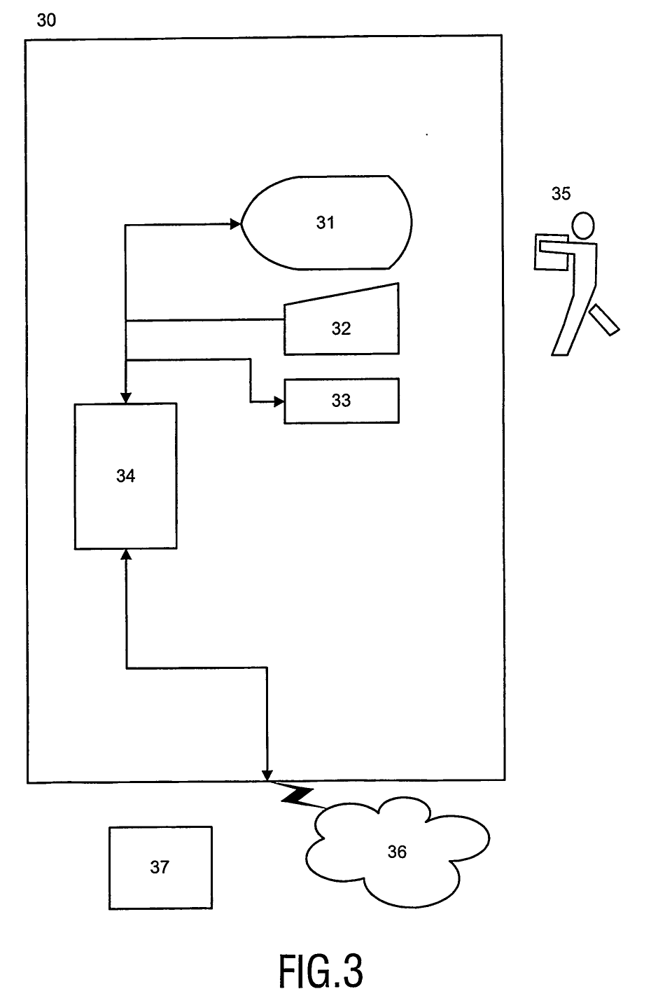

FIG. 3 shows a media system and a computer readable medium.

FIG. 1 shows a data-structure. In this figure a principle of the data-structure stored on the system device is shown. The data are stored in a structure comprising two dimensions. The first dimension, the M's, the modes—which may also be considered as data along the X-axis in the figure—may represent different modes, where each of these modes may represent a context of the user.

The second dimension, the P's, the preferences—which may also be considered as data along the Y-axis in the figure—may represent different preferences, where each of these preferences may represent—when given or having a value of “1” or “0”—a set or a non set preference. The preferences may be used—when an information item is to be presented—to determine how said information item is presented on a media system of the user.

Generally, when the wording “information item is to be presented”, this is meant to include the display of the information item on the media system with playback of sounds, music, speech, etc, if any, on the media system.

As an example, P's on the second dimension may have the following meaning in the case they all, individually, have a value of “1″”, i.e. a set value:
P1: present all content in all possible ways,
P2: present sound,
P3: present images,
P4: present text,
P5: present audio
P6: present the text in the form of a generated speech,
P7: present links,
P8: alert to an incoming call
P9: alert to a received SMS, and
P10: alert to an incoming mail.

Correspondingly, the P's, the preferences on the second dimension may have the following meaning in the case they all, individually, have a value of “0”, i.e. a non set value:
P1: present no content at all,
P2: present no sound,
P3: present no images,
P4, present no text,
P5: present no audio
P6: do not present the text in the form of speech,
P7: present no links,
P8: do not alert to an incoming call
P9: do not alert to a received SMS, and
P10: do not alert to an incoming mail.

As a consequence, a mode on the first dimension—as shown—has information about P1 to P10 with, generally, either a “0” (non set value) or a “1” (a set value), individually, on each of the P's.

As an example from the figure, the mode M1 has the values of its preferences: P1=0. P2=1, P3=1, P4=0, P5=1, P6=1, P7=1, P8=1 and P9=1, which may determine that the media content item presented in the Mode M1 may have to be presented with the following preferences:
P1: display the media content item with no content at all
P2: playback the media content item with sound,
P3: display the media content item with images,
P4: display the media content item with no text,
P5: playback the media content item with audio
P6: playback the text of the media content item in the form of a generated speech,
P7: display the media content item with links,
P8: present the media content item with an alert to an incoming call, and
P9: present the media content item with an alert when a SMS is received.

It may be a self-contradiction that the preference of P1 determines “display the media content item with no content at all”, when the other preference settings of M1 are considered, i.e. when P2 to P9 are considered in combination with P1. Generally, in a particular implementation, different rules may be applied to solve apparently self-contradictions among the preferences. Such rules may determine which setting(s) of which preference(s)—in the case of an inconsistency between two or more settings given—that should prevail.

It may even be the case that two or more preferences of presentation are combined. As an example the preferences—in short text—audio-only (render the web page using speech) and links-only may be combined. Other preferences of presentation may be provided depending on the media system, contexts and/or mode of use. When the user chases to bookmark a web site, the user may be prompted to choose one (or more—they need not be mutually exclusive) preferences of presentation. Whenever the bookmark is later accessed, the content, i.e. a web page, is accessed belonging to the bookmark list, said web page may be presented with the chosen preferences of presentation, i.e. the setting corresponding to the chosen mode. Further, alerts (for incoming mail or SMS, incoming telephone call) during presentation may be allowed or may be switched off.

Generally, a mode may have a set of preferences, where each preference of the set may be either be individually set or non set, where the set preference may mean that a given information item (which may be a link referring to some content) should, possibly be presented with the set preference(s), and vice versa for the non set preference(s).

As an example, if the given information item is a link to a text and the only preference that is set (of a selected mode) is P6, then the media system subsequently may have to playback, i.e. in this special case only to emit audio, the text in the form of a generated speech.

The modes M1 to M6 shown may be allocated a name or a symbol in order readily to associate and recognize them, when the user desires to either watch the preferences of a mode or to select, i.e. to switch to, another mode.

Even though only nine preferences and six modes are shown, the first dimension may be extended to any higher number of modes and, correspondingly, the second dimension, may be also be extended to any higher number of preferences.

FIG. 2 shows a method of presenting an information item from a first set of information items on a media system.

Each information item of the first set of information items may be accessible by a reference, which may be a link, e.g. an URL as a Web or a Wap address known from the world of the Internet. Said first set of information items may be a list of bookmarks, i.e. it may be a list of preferred links or URL's previously provided to the media system.

Each reference (link) for a given information item may comprise a second set of preferences, where each preference of the second set may have a given or a predetermined value. The second set of preferences, each with a value of either “0” or “1”, may be the preferences P1 to P9 shown in FIG. 1.

By a comparison with the prior art browsers, it may be understood as if additional fields (i.e. the second set of preferences) were added to the so called bookmark list. The fields are used to store a set of flags, i.e. each flag with a value of “0” or “1”, identifying how the linked web page should be rendered to the user by use of various parameters (P1 through P9 of FIG. 1), i.e. how said web page should be displayed and/or played back on the media system

In step 99, the method is started. Variables, flags, buffers, information items, content of information items, preferences, modes are set to default states of the media system. When the method is started a second time on the media system, only corrupted variables, flags, buffers, information items, preferences, content of information items, modes are reset to default values by the media system.

In step 100, the information item—as discussed it may be accessible by an URL link—may be presented on the media system. Said information item may belong to the first set of information items, i.e. said list of bookmarks. In other words the information item, i.e. the content referred to by the link, may be presented on the media system in a particular presentation format.

The presentation format of said information item (when it is subsequently presented on the media system) may be dependent of the values of the second set of preferences, which belong to said information item. In other words, said presentation format may be determined by means of the values (set or non set) in the second set of preferences, which were shown in FIG. 1 by means of the preferences P1 to P9.

Generally speaking, in step 100 a link, i.e. the content of the content linked to, is presented on the media system. The link may be provided from a bookmark list and the content of the link may be presented with the preferences belonging to the link. The preferences may determine how, i.e. with or without sound, images, text, audio, speech, etc, said content is presented on the media system.

Generally, when the wording “information item may be presented” or similar wording is used, it is meant to include the display of the information item on the media system with playback of sounds, music, speech, etc, if any, on the media system. However, any elements of the information item that fall outside the selected presentation format (dependent of the values of the second set of preferences) are not presented.

Further, in step 100, the values of the second sets of preferences may further be dependent of a mode selectable from a third set of modes. Each mode of the third set of modes may represent a context of a specific user. As a consequence, said presentation of the information item on the media system—as just above explained—may also be dependent of the given mode. With reference to the FIG. 1, the presentation of the information item may be dependent of the given mode, and thereby—more detailed—dependent of the particular setting of the preferences belonging to said mode. Also with reference to the FIG. 1, the third set of modes may represent the context of a specific user, it may be any one of the modes M1 through M6 as shown.

The context—represented by a chosen mode—of the user may generally be a situation wherein a particular media system is used. The situation—as discussed in the following steps—may be a participation in a meeting, during driving, in an office conference, etc. In other words, the context may therefore be a combination of said situation and the presentation capabilities (display, size of display, playback, etc) of the particular media system used.

In summary, the information item, i.e. the content linked to, may be presented on the media system with the preferences of the given mode belonging to the link.

In step 200, a mode may be selected on the media system. The mode may be selected from said third set of modes. Step 200 constitutes a generalisation of steps 201, 202 and 203. The mode selected may be any one of modes M1 through M6 as mentioned in FIG. 1.

The user may be in a context, i.e. a selected mode, where he desires by way of an example—as a first goal—to read fast through web pages of a particular book mark, i.e. the user may desire to skim fast through the newspapers from various Web pages, and therefore does not want to be concerned with time consuming moving graphics, movies, flashing promotion material etc., when visiting these newspapers on the Internet. This mode may be M3 from FIG. 1, where only a minimum of preferences has the value “1”.

However the same user may be in another context—as a second goal—where he now desires, i.e. to select another mode than the previously selected, by way of the continued example to now watch the same web pages of the particular book mark with full content, i.e. the user may now desire to read said newspapers but additionally he also wishes to watch non readable content, and therefore actually desires to have all information possible contained in said web pages presented to him, i.e. all available graphics, movies, promotion material, audio, video, etc., when visiting these newspapers on the Internet. This mode may be M1 or M4 from FIG. 1, where the most of the values of the preferences has the value “1”.

In yet another situation where some pages are viewed while the user is engaged in an activity where a different presentation mode may be required, e.g. while the user is in a context of a meeting. During the meeting the user may desire to browse through various web pages but does not want to have any sounds emitted from the browsing, as the sound may disturb the meeting. In this case, a “meeting” mode of presentation of web pages may be desired. In that case the user may select a mode of M2, where the preferences of P2, P5 and P6 all have the value of “0”, i.e. (P2) present no sound, (P5) present no audio and (P6) do not present the text in the form of speech.

However, the value of P9 of “1”, i.e. alert to a received SMS, may still disturb the user, so he may desire to change the value of P9 to “0”, i.e. do not alert to a received SMS. This may be performed by means of steps 300 through 304.

Alternatively, the user may choose mode M3 where the value of P9 is already “0”.

In another example the user may be in a context where the user is driving a car and only carries with him a media system such as a tiny web browsing device, i.e. as an example a Personal Digital Assistant, with a small display and thereby with limited presentation capabilities. In this case, a “driving” mode of presentation of web pages may be desired, in this situation it may be convenient during the driving that the Personal Digital Assistant being used primarily loudly the web pages through loudly by means of a voice to a loudspeaker or a set of headphones. In that case the user may desire to select a mode where the selected mode has “1” on the value P6: play the text of the media content item in the form of a generated speech. It may then be mode M1, M4 or M6.

In step 201, the values of the preferences for at least one mode may be presented, if any, from the third set of modes.

In this step said preferences P1 through P9 from FIG. 1 with their corresponding values are presented on the media system for at least one mode, thereby the user of the media system may watch how the particular preferences are for the mode(s), he desires to consider, before any selection of a new mode in step 203 may be performed.

In step 202, a representation of at least one mode belonging to the third set of modes may be presented on the media system. As an alternative to the foregoing step, the media system may present a representation of one or more modes on the media system. The representation may be performed by means of a name, a symbol, an icon, etc of each mode presented. Hereby, the user of the media system may readily recognize a given mode and further he may associate to the previously set preferences of the given particular mode.

In step 203, a second mode may be selected on the basis of a user input, wherein the second mode is selected from the third set of modes. In this step the user of the media system has either passed step 201 or step 202, and is in this step ready to select a second mode among said third set of modes. The third set of modes may be modes M1 through M6 from FIG. 1.

In step 300, the values of the second sets of preferences may be modified, where the values belong to the selected mode. Step 300 constitutes a generalisation of steps 301 through 303. On the media system the user may modify one or more preferences of the second set. The second set of preferences belongs to the currently selected mode.

The user may be in a context where he desires by way of an example to stay in given (previously selected) mode, e.g. “office” mode, as an example to read fast through web pages of a particular book mark, i.e. the user may desire to skim fast through the newspapers from various Web pages, and therefore only wishes the textual information presented on his media system in the form of a raw text, etc., when these newspapers are visited on the Internet. This may be appropriate when the user has a simpler media system such as a tiny Personal Digital Assistant, but also when the user has a more advanced media system such as a Web-TV.

However, the same user may desire to continue to use his media system in the same context, i.e. in the same “office” mode, whereas he now desires—by way of the continued example—to read very carefully through the same web pages of the particular book mark, i.e. the user may now desire to have said newspapers presented to him will all information possible contained in said web pages, i.e. all available graphics, movies, promotion material, sound, music, voice, etc., when visiting these newspapers on the Internet by means of his media system. Therefore, he needs to modify one or more values of the second set of preferences for the given selected mode. In this example the preferences of P2, P3, P5, P7 are to be considered in a modification, where each of these may be given the value “1”, i.e. to achieve that he now has his content, i.e. said web pages, presented by use of the preferences: “play the content with sound”, “display the content with images”, “play the content with audio”, and “display the content with links”, if any.

In step 301, the values of the second sets of preferences may be presented on the media system. Here the media system may present the currently selected second sets of preferences of the currently selected mode. It is appropriate for the user to have these preference presented to him in order to readily modify and store these if so desired in the next two steps. It may be the case that the media system presents said preferences with filled in or non filled in check boxes for each check box belonging to a particular preference; in other words the checked check boxes may represent the “1”'es from FIG. 1, whereas non-checked check boxes may represent the “0”'es from FIG. 1.

In an example the user being may be in context where he is driving a car and only carries with him media system such as a tiny web browsing device, i.e. as an example a Personal Digital Assistant, with a small display and with limited presentation capabilities. In thiscase, a “driving” mode of presentation of web pages may be used during the drive. The situation may be that the Personal Digital Assistant primarily emits the contained textual information of the web pages loudly by means of a voice to a loudspeaker or a set of headphones. In that case the user may already have selected a mode where the selected mode has “1” on the value P6: play the text of the media content item in form of a generated speech. It may be mode M1. However, the user may be dissatisfied with some of the value of the other preferences of mode M1, and therefore he makes the media system present the values of the preferences for mode M1 in this step, in order to be prepared for a subsequent change, if any, of some of the preferences.

In step 302, on the basis of a user input, at least one value of the second set of preferences may be modified. It may be the case that the second set of preferences may be modified by clicking into said check boxes mentioned in the foregoing step. As an example, if a setting is “0” it may be set to “1” by clicking the preference in the check box, and correspondingly a previously set preference, i.e. a “1”, may be deselected again (to a “0”) by yet another click in the same check box.

Continuing the example with the user driving a car with his Personal Digital Assistant in mode M1, he may in this step modify one or more of the values of the preferences of mode M1 to a more suitable presentation, but still in mode M1.

In step 303, the modified value may be stored to the second set of preferences. When the user of the media system has gone through all the values of the second set of preferences he desired to modify, he may then subsequently store them.

Still continuing the example with the Personal Digital Assistant in mode M1, the user may in this step store one or more of the (previously changed) values belonging to the preferences of mode M1.

In step 400, a third mode, on the basis of a user input, may be added to the third set of modes. The user of the media system may desire to add a new mode (said third mode) to his number of available modes (said third set of modes). The user may have a new job-situation, another interest of media content (i.e. other links to other information items), an additional other or different media system, another interest of presentation, etc, and therefore he desires to add a new mode to his media system. As also discussed in step 202, the user may in this step add some kind of symbolic representation in order to better associate to said third mode. The representation may be a name, a symbol, an icon, etc.

In step 401, a fourth mode, on the basis of a user input, may be removed from the third set of modes. The user of the media system may delete an old mode (said fourth mode), i.e. to remove it from his available modes (said third set of modes). The user may have another situation with respect to job, information items, presentation format, etc, and therefore he desires to remove the old mode from his media system.

In step 500, the information item, in the presentation format of the selected mode, may be retrieved from a server to the media system. In this step said information item may be retrieved, i.e. a content of said information item may be downloaded from a server to the media system. The content of the information item may, due to newly set preferences or due to a newly set mode not be presentable any more and therefore there may be a requirement to retrieve the content (again) in the corresponding new presentation format of a given mode. Alternatively, the content of the information item may not be present on the media system, and therefore the content of the information item need to be retrieved from said server.

Generally, any elements of the information item that fall outside the selected presentation format are not presented in step 100, and where possible are not downloaded to the media system in this step. For example, where the user has selected that images should not be displayed in his mode, images will not be downloaded. It may be the case that the information item, e.g. a web page, was previously downloaded with the images, but still it is possible for the method by the use of the preferences (of a mode) to omit the images in a subsequent presentation in step 100; in this case, the web page without images is not downloaded in step 500.

Usually, the method will start all over again as long as the media system where the method is implemented and executed is powered. Otherwise, the method may terminate in step 600; however, when the media system is powered again, the media system may proceed from step 100 again.

FIG. 3 shows a media system and a computer readable medium. The media system, which may be a Web-TV, a browser or a Web device, is shown by reference numeral 30. A user as indicated by reference numeral 35 may operate the media system and have information presented on the media system. During the operation of the media system the user may have information presented as indicated by reference numeral 31 on a display. During the operation of said media system the user, reference numeral 31, may further have various audio information presented to him by means of a speaker as indicated by reference numeral 33. The user may respond to an instruction given by the display by means of an input device as shown by reference numeral 32. The input device may be a keyboard, fields sensitive to touch, a mouse, etc. The media system of reference numeral 30 may further have a processor, as indicated by reference numeral 34. The processor is arranged to receive inputs from the input device and by means of a connection, e.g. the Internet connection as indicated in reference numeral 36. The processor, which—as was explained in FIG. 2, may then present information by means of the display, reference numeral 31 and the speaker as indicated by reference numeral 33. The processor is further used to perform said steps of said method.

The computer readable medium is shown by means of reference numeral 37. The computer program product may be designed to perform said steps of said method.

The computer readable medium may be magnetic tape, optical disc, digital video disk (DVD), compact disc (CD or CD-ROM), mini-disc, hard disk, floppy disk, smart card, PCMCIA card, etc.

A Web device may a mobile phone, a Personal Digital Assistant, Web tablet or any other electronic device used in moving Internet applications capable of requesting and displaying and or presenting Web page content.

1. A method of presenting an information item from a first set of information items on a media system (30), wherein each information item of the first set of information items is accessible by a reference, and wherein each reference for a given information item comprises a second set of preferences, each preference of the second set having a predetermined value, said method comprising the step of:
presenting (100) a given information item from the first set of information items where the presentation format is dependent of the values of the second set of preferences belonging to the given information item.

2. A method according to claim 1, characterized in that the values of the second sets of preferences is further dependent of a mode selectable from a third set of modes, each mode of the third set representing a context of a specific user (35).

3. A method according to claim 2, characterized in that the method further comprises the step of
selecting (200) a mode, wherein the mode selected is selected from the third set of modes.

4. A method according to claim 3, characterized in that the method further comprises the step of:
modifying (300) the values of the second sets of preferences belonging to the selected mode.

5. A method according to claim 4, characterized in that the step (200) of selecting a mode comprises the sub-steps of:
presenting (201) the values of the preferences for at least one mode, if any, from the third set of modes; or
presenting (202) a representation of at least one mode belonging to the third set of modes; and
selecting (203) a second mode on the basis of a user input,
wherein the second mode is selected from the third set of modes.

6. A method according to claim 5, characterized in that (300) the step of modifying the values of the second sets of preferences belonging to the selected mode comprises the sub-steps of:
presenting (301) the values of the second sets of preferences;
modifying (302), on the basis of a user input, at least one value of the second set of preferences; and
storing (303) the modified value to the second set of preferences.

7. A method according to claim 6, characterized in that the method further comprises the sub-steps of:
adding (400) a third mode, on the basis of a user input, to the third set of modes; or
removing (401) a fourth mode, on the basis of a user input, from the third set of modes.

8. A method according to claim 7, characterized in that the method further comprises the step of:
retrieving (500) the information item in the presentation format of the selected mode from a server to the media system.

9. A computer system for performing the method according to claim 1.

10. A computer program product comprising program code means stored on a computer readable medium (37) for performing the method of claim 1 when the computer program is run on a computer.

11. A media system (30) for presenting an information item from a first set of information items, wherein each information item of the first set of information items is accessible by a reference, and wherein each reference for a given information item comprises a second set of preferences, each preference of the second set having a predetermined value, said media system comprising:
means for presenting (31, 33) a given information item from the first set of information items where the presentation format is dependent of the values of the second set of preferences belonging to the given information item.

12. A media system according to claim 11, characterized in that the values of the second sets of preferences is further dependent of a mode selectable from a third set of modes, each mode of the third set representing a context of a specific user (35).

13. A media system according to claim 12, characterized in that the media system further comprises:
means for selecting (32) a mode, wherein the mode selected is selected from the third set of modes.

14. A media system according to claim 13, characterized in that the media system further comprises:
means for modifying (32) the values of the second sets of preferences belonging to the selected mode.

15. A media system according to claim 14, characterized in that the means for selecting a mode comprises:
means for presenting (31) the values of the preferences for at least one mode, if any, from the third set of modes; or
means for presenting (31) a representation of at least one mode belonging to the third set of modes; and
means for selecting (32) a second mode on the basis of a user input, wherein the second mode is selected from the third set of modes.

16. A media system according to claim 15, characterized in that the means for modifying the values of the second sets of preferences belonging to the selected mode comprises:
means for presenting (31) the values of the second sets of preferences;
means for modifying (32) at least one value of the second set of preferences; and
means for storing (34) the modified value to the second set of preferences.

17. A media system according to claim 16, characterized in that the media system further comprises:
means for adding (32) a third mode to the third set of modes; or
means for removing (32) a fourth mode from the third set of modes.

18. A media system according to claim 17, characterized in that the media system further comprises: means for (34) retrieving the information item in the presentation format of the selected mode from a server to the media system.
